(19) United States
(12) Patent Application Publication
(10) Pub. No.: US 2015/0149539 A1
(43) Pub. Date: May 28, 2015

(54) Trending Data Demographics

(71) Applicant: Adobe Systems Incorporated, San Jose, CA (US)

(72) Inventors: Saurabh Shukla, West Bengal (IN); Vinayak Agarawal, Delhi (IN); Rajan Bhargava, Andhra Pradesh (IN); Mohit Garg, Delhi (IN)

(73) Assignee: Adobe Systems Incorporated, San Jose, CA (US)

(21) Appl. No.: 14/087,558

(22) Filed: Nov. 22, 2013

(51) Int. Cl. H04L 29/08

(52) U.S. Cl. CPC H04L 67/22
USPC 709/204

(57) ABSTRACT

Trending data demographics are described. In one or more implementations, content posted on online content sources is analyzed to determine topics associated with the posted content. Analysis is then performed to ascertain which of those topics in the posted content are trending. A determination as to which of the topics are trending may be based on a number of times the posted content involves a topic. For the topics that are trending, demographic data of the users that posted about those topics is collected. In some cases, demographic data may be assigned to users that posted about the topics that are trending. Based on the collected and assigned demographic data, a prediction is made to predict segments of users that are likely to find the trending topics interesting. Targeted content may then be provided to the segments of users that are likely to find the trending topics interesting.

### BACKGROUND

Users post a vast amount of content to various web service providers, such as to social network services. With the proliferation of social network use, many users have become comfortable offering their own insights regarding topics that interest them by posting about those topics online. Oftentimes, certain topics will be of interest to many such users. Consequently, many users may be inclined to post content involving those topics.

Take the release of a blockbuster movie, for example. Many users may be interested in seeing the movie or have thoughts to share regarding their expectations for the movie. Around the movie's release date, these users may share their interest or those thoughts by posting about the movie online. Accordingly, the movie may be posted about by users more so than many other topics and as a result, the movie may “trend” among the topics being posted about online. Clearly, users that post about a trending topic exhibit at least some interest in the topic. Other users, however, may also be interested in the trending topic even though they did not post about it and therefore it may be difficult to locate such users using conventional techniques.

### SUMMARY

Trending data demographics techniques are described. In one or more implementations, content posted on online content sources is analyzed to determine topics that are associated with the posted content. Analysis is then performed to ascertain which of those topics in the posted content are trending. A determination as to which of the topics are trending may be based, in part, on a number of times the posted content involves a topic. For the topics that are trending, demographic data of the users that posted about those topics is collected. Based on the collected demographic data, a prediction is made to predict segments of users that are likely to find the trending topics interesting. Targeted content may then be provided to the segments of users that are likely to find the trending topics interesting.

Rather than collecting demographic data from profiles of users that posted about a trending topic, demographic data may instead be assigned to those users. For some of the users that posted about a trending topic, their demographic data simply may not be collectible from the online content sources. This may be the case, for instance, when a user that posted about a trending topic has opted to keep portions of an associated user profile from being made publicly available. For many of the users that post content to online content sources, however, demographic data may be available. The demographic data of those users may be collected and used to segment the users into one or more segments according to the demographic data. Consequently, characteristics exhibited in much of the content posted to online content sources may be attributed to the segments of users that posted the content. Based on a determination that content posted about a trending topic exhibits characteristics attributed to one or more of the segments, demographic data associated with those segments may be assigned to a user that posted about the trending topic. Thus, a prediction can be made to predict segments of users that are likely to find a trending topic interesting based on the demographic data assigned to the users that posted about the trending topic. Targeted content may then be provided to the segments of users that are likely to find the trending topic interesting. In one or more implementations, the characteristics attributed to the segments of users may be updated based on additional content posted on the online content sources and the demographic data of the users that posted the additional content.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques described herein.

FIG. 2 illustrates from the environment from FIG. 1 a service provider and a computing device having a trending data demographics module in greater detail.

FIG. 3 is a flow diagram depicting a procedure in an example implementation in which demographic data is collected for users that have posted about trending topics and is used to predict segments of users that are likely to find the trending topics interesting.

FIG. 4 is a flow diagram depicting a procedure in an example implementation in which data is assigned to users that have posted about trending topics to predict segments of users that are likely to find the trending topics interesting.

FIG. 5 illustrates an example system including various components of an example device that can be employed for one or more implementations of trending data demographics techniques described herein.

### DETAILED DESCRIPTION

Overview

Businesses may be limited in the ways in which they target content (e.g., advertisements, search results, recommendations, and so on) to users, in part, because conventional techniques fail to determine an audience of users that is likely to be interested in trending topics.

Trending data demographics techniques are described. In one or more implementations, the demographics of users that post about trending topics are used to provide targeted content to segments of users that are likely to find the trending topics interesting. To do so, topics may be associated with content that is posted by users to one or more online content sources, e.g., social network services, blogging services, news services, and so forth. Given the topics posted about in the online content, a determination may be made as to which of those topics are trending. Whether a particular topic is trending may be based, in part, on a number of times the topic is posted about, such that the topics that are posted about the most may be considered to be trending. For the topics that are trending, demographic data (e.g., age, gender, and location) is collected for the users that posted about those topics and whose demographic data is collectible (e.g. from a user profile).

For some users that posted about a trending topic demographic data may not be collectible, however. This may be the case, for instance, when a user that posted about a trending topic has opted to keep portions of their user profile from being made publicly available. Rather than collect demographic data, demographic data may instead be assigned to those users. Naturally, content posted to the one or more online content sources may exhibit certain characteristics, such as a use or absence of certain grammatical elements (e.g., punctuation), a use or absence of delimiters or features made available by a content source in conjunction with posts (e.g., hashtags, emojis, incorporation of digital pictures, and so on), a use or absence of certain phrases, and the like. Consequently, characteristics exhibited in much of the content posted to online content sources may be attributed to certain demographic segments of users that posted the content. Thus, a user for which demographic data is not collectible may be assigned demographic data based on characteristics identified in content posted by that user.

Regardless of how demographic data is associated with the users that post about a trending topic (e.g., collected for or assigned to), the demographic data for those users may be used to predict segments of users that are likely to find a trending topic interesting.

In the following discussion, an example environment is first described that may employ the techniques described herein. Example implementation details and procedures are then described which may be performed in the example environment as well as other environments. Consequently, performance of the example procedures is not limited to the example environment and the example environment is not limited to performance of the example procedures.

Example Environment

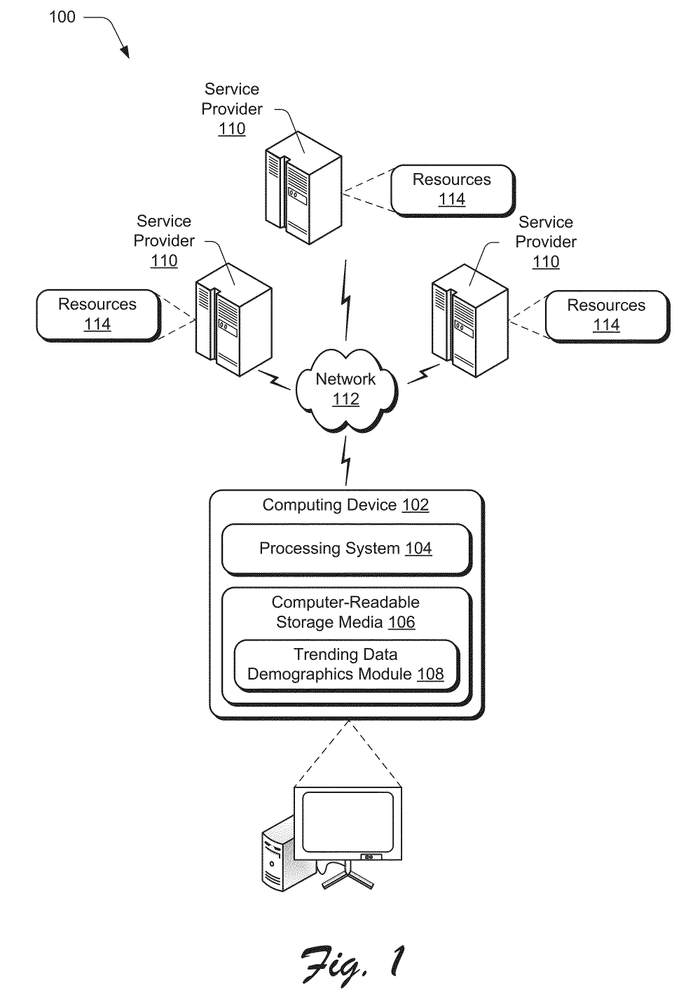

FIG. 1 is an illustration of an environment 100 in an example implementation that is operable to employ techniques described herein. The illustrated environment 100 includes a computing device 102 having a processing system 104 that may include one or more processing devices (e.g., processors), one or more computer-readable storage media 106, and a trending data demographics module 108 embodied on the computer-readable storage media 106 and operable via the processing system 104 to implement corresponding functionality described herein. In at least some implementations, the computing device 102 may include functionality to access various kinds of web-based resources (content and services), interact with online providers, and so forth as described in further detail below.

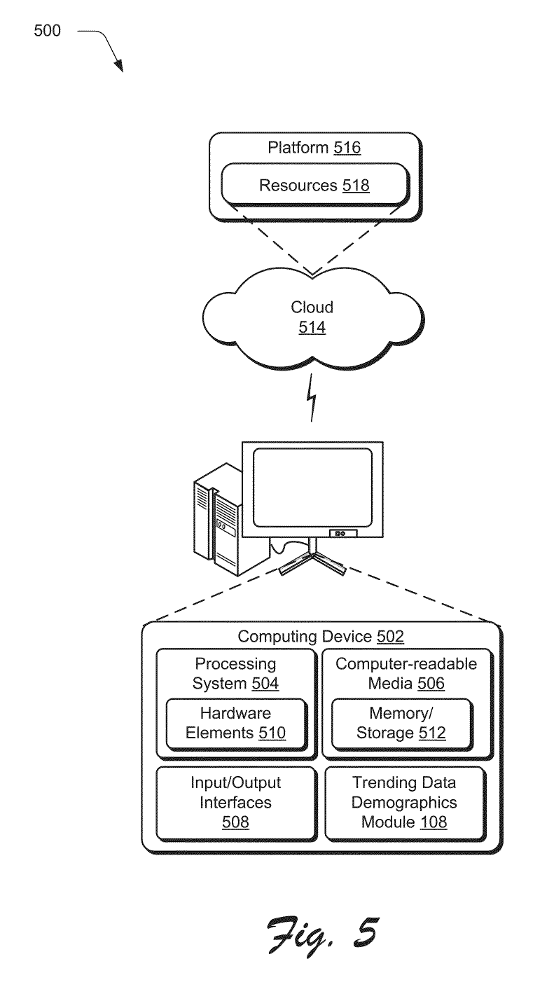

The computing device 102 may be configured as any suitable type of computing device. For example, the computing device 102 may be configured as a server, a desktop computer, a laptop computer, a mobile device (e.g., assuming a handheld configuration such as a tablet or mobile phone), a tablet, a device configured to receive gesture input, a device configured to receive three-dimensional (3D) gestures as input, a device configured to receive speech input, a device configured to receive stylus-based input, a device configured to receive a combination of those inputs, and so forth. Thus, the computing device 102 may range from full resource devices with substantial memory and processor resources (e.g., servers, personal computers, game consoles) to a low-resource device with limited memory and/or processing resources (e.g., mobile devices). Additionally, although a single computing device 102 is shown, the computing device 102 may be representative of a plurality of different devices to perform operations “over the cloud” as further described in relation to FIG. 5.

The environment 100 further depicts one or more service providers 110, configured to communicate with computing device 102 over a network 112, such as the Internet, to provide a “cloud-based” computing environment. Generally speaking, service providers 110 are configured to make various resources 114 available over the network 112 to clients. In some scenarios, users may sign up for accounts that are employed to access corresponding resources from a provider. The provider may authenticate credentials of a user (e.g., username and password) before granting access to an account and corresponding resources 114. Other resources 114 may be made freely available, (e.g., without authentication or account-based access). The resources 114 can include any suitable combination of services and/or content typically made available over a network by one or more providers. Some examples of services include, but are not limited to, social network services (e.g., Facebook®, Twitter®, Instagram®, LinkedIn®, and the like), blogging services, news services, and so forth.

These services may serve as sources of significant amounts of online content. Such content may include various combinations of text, video, ads, audio, multi-media streams, animations, images, web documents, web pages, applications, device applications, and the like. Further, the content that is made available through the services may be posted by users that have accounts with those services. For example, a user having an account with a social network service may post content, such as status updates, pictures, videos, and links, to a page associated with the user. Additionally, a user of a social network may be able to post content to other pages of the social network, including those associated with other users, businesses, and so on.

The trending data demographics module 108 may represent functionality to implement trending data demographics techniques as described herein. For example, the trending data demographics module 108 may be configured in various ways to predict what demographic segments of users are likely to find a topic interesting that is trending in content posted to online content sources. To do so, the trending data demographics module 108 may be configured to first ascertain which topics posted about in online content sources are trending. As part of ascertaining which topics in the content are trending, the trending data demographics module 108 may be configured to determine how many times the content posted on the online content sources involves a topic.

Once a topic is determined to be trending, the trending data demographics module 108 may collect demographic data (e.g., gender, age, location) for the users that posted about the trending topic. In other instances, the trending data demographics module 108 may be configured to assign demographic data to users that posted about the trending topic. For example, the trending data demographics module 108 may assign demographic data to a user when a profile associated with the user cannot be accessed to collect the demographic data for the user. This may be the case in which the user has chosen not to publicly share certain information included as part of their profile.

Regardless of whether the demographic data is collected for or assigned to the users that posted about a trending topic, that demographic data may enable the trending data demographics module 108 to determine segments of users that are likely to find the trending topic interesting. Given the segments of users that are likely to find the trending topic interesting, the trending data demographic module 108 may cause targeted content (e.g., advertisements, suggestions for additional content, and so on) to be provided to those segments.

The trending data demographics module 108 may be implemented as a software module, a hardware device, or using a combination of software, hardware, firmware, fixed logic circuitry, etc. Further, the trending data demographics module 108 may be implemented as a standalone component of the computing device 102 as illustrated. In addition or alternatively, the trending data demographics module 108 may be configured as a component of a web service, an application, an operating system of the computing device 102, a plug-in module, or other device application as further described in relation to FIG. 5.

Having considered an example environment, consider now a discussion of some example details of the techniques for trending data demographics in accordance with one or more implementations.

Trending Data Demographics Details

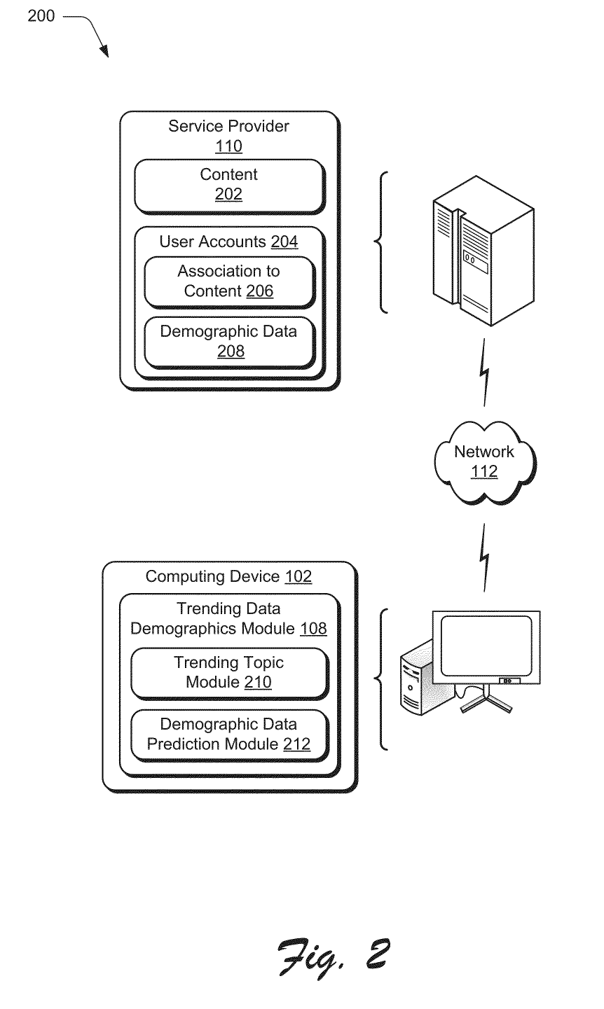

This section describes some example details of trending data demographics techniques in accordance with one or more implementations. FIG. 2 depicts generally at 200 some portions of the environment 100 of FIG. 1, but in greater detail. In particular, the computer-readable storage media 106, the service provider 110, and the components included therein are depicted in greater detail.

In general, the service provider 110 depicted in FIG. 2 serves as a source of online content, such as content 202. As discussed above, the service provider 110 may correspond to a social network service (e.g., Facebook, Twitter, Instagram, LinkedIn, and the like), a blogging service, a news service, or any other source of online content. In addition to having content 202, the service provider 110 is depicted as including user accounts 204. The user accounts 204 may each be associated with a particular user and include associations to content 206, such as associations to content posted by users of the accounts. When a user posts a status update, for instance, a username associated with the user's user account 204 may be posted alongside the status update. The username may also be indicated when a user is tagged in a post, such as when the user is tagged in a post including a photograph. Thus, the “tag” may serve as an association to content 206. A user account 204 may be associated with content in several other ways without departing from the scope of the techniques described herein.

The user accounts 204 also include demographic data 208. The demographic data 208 of a user account 204 may include a variety of information describing a user of the account. For example, the demographic data 208 may include the user's gender, age, location, highest level of education completed, employer, relations to other users, interests, and so on. Although the demographic data 208 is depicted as being part of the user accounts 204, some demographic data may be determined without collecting that information from the user accounts, and thus may not be included as part of them. A user's location, for instance, may be determined in a variety of ways without being collected from a user account 204. In some implementations, a user's location may be determined based on time zone information corresponding to a post made by the user. Along with posting content, a user may be able to “check-in” to a nearby place (e.g., restaurant, bar, park, school, city, event, hotel, business, and so on) to associate that place with the content the post. Consequently, the place indicated by a “check-in” may be used to ascertain location information for a user. An IP address or global positioning system (GPS) coordinates of a device from which a user posts content may also be used for a location of the user. The location of a user may be determined without collecting that information from a user account of the user in yet other ways without departing from the scope of trending data demographics.

In general, the content 202 and at least some information of the user accounts 204 (e.g., the associations to the content 206) may be accessible by the trending data demographics module 108 to implement trending data demographics. The trending data demographics module 108 includes a trending topic module 210 and a demographic data prediction module 212. Although the trending data demographics module 108 is depicted having these two separate modules, the functionality represented by the trending topic module 210 and the demographic data prediction module 212 may be implemented using more or fewer modules.

Regardless of how implemented, the trending topic module 210 represents functionality of the trending data demographics module 108 to ascertain which topics, posted about on one or more online content sources, are trending. To do so, the trending topic module 210 may be configured to associate topics with content posted to the one or more online content sources. For example, the trending topic module 210 may process content posted to the online content sources to extract key words. The key words extracted from the content may indicate one or more topics to which the posted content pertains.

The trending topic module 210 may determine topics associated with content posted to the online content sources by extracting items from the content that are delimited by one or more delimiting characters. The use of a delimiter may have special meaning for a particular online content source or across multiple different online content sources. A term that is “hashtagged” (preceded by a “#”), for instance, may indicate an intention for the hashtag (the hashtagged term) to be used in conjunction with content related to that term. To find content related to a hashtagged term, users may search for a particular hashtag. In any case, when content posted to an online source includes a hashtag, the hashtag may be considered a topic of the posted content.

Content posted to an online source may include other delimiters, which may be indicative of a topic of the posted content. When an entity is a topic of posted content, for instance, it may be indicated by including “@” before a name of the entity. By including “@” before the name of the entity, content posted on an online source may reference (e.g., link to) a user profile of the entity with the online content source. Although the delimiters “#” and “@” are discussed as giving certain significance (or functionality) to content used therewith, these characters may instead be used to give content other significance (or functionality) than that which is discussed. Alternately, the use of “#” or “@” in conjunction with content may convey no special meaning about the content posted therewith. It should be appreciated that other delimiters may be used to append certain significance to content posted by users and, therefore, may also be used to determine topics that are associated with the content.

Additionally, the trending topic module 210 may determine topics associated with content posted to the online content sources by extracting uniform resource locators (URLs) from the content. The character string constituting a URL may be indicative of a topic pertaining to the content that includes the URL. For example, posted content may include the URL “www.howtobbqribs.com.” Naturally, the URL “www.howtobbqribs.com” may indicate that the content posted in conjunction with this URL is related to barbequing ribs. In addition or alternately, the resource that is referenced by a URL may indicate topics pertaining to the content that includes the URL. A URL, for instance, may reference a particular web page or website. The content of the web page or website referenced by the URL may be analyzed to determine one or more topics of the web page or website. Accordingly, the topics of the web page or website referenced by the URL may be associated with the content posted to the online content sources that includes the URL. Although a variety of ways in which the trending topic module 210 may associate topics with content posted to online sources are discussed herein, the trending topic module may associate topics with such content in ways that have not been discussed without departing from the scope of trending data demographics.

Having determined what topics are associated with the content that is posted to the online content sources, the trending topic module 210 may be configured to ascertain which of those topics are trending. Whether a topic is “trending” may be relative to other topics that are posted about in content on the online content sources. A trending topic may, for instance, be a topic that is posted about more than other topics. Specifically, a trending topic may be one that is involved in posted content a greater number of times than other topics. However, the number of times a topic is involved in posted content may exclude posts that constitute a repost of content originally posted by someone else. For example, a first user of the social networking service Twitter® may “tweet” (the act of posting content via Twitter®, but also the term used for the post itself) about a topic and the tweet may, in determining whether the topic is trending, be counted as one of the number of times that content involves the topic. However, when a second user retweets (the act of reposting the content originally tweeted by the first user and designating the repost accordingly) the content tweeted by the first user, it may not be counted as one of the number of times that content involves the topic.

In any case, a trending topic may be a topic that is involved in content a greater number of times over a certain period of time than other topics. In some implementations, topics may be ranked according to a number of times each topic is involved in the posted content or according to a number of times each topic is involved in the posted content over the certain period of time. In this way, topics that are ranked above a certain rank may be considered trending topics while topics that are ranked below the certain rank are not considered to be trending topics. In some implementations, a trending topic may simply be a topic that is posted about more than a threshold number of times (or more than a threshold number of times over a time period). Accordingly, topics that are posted about more than the threshold number of times may be considered to be trending and topics that are posted about fewer than the threshold number of times are not considered to be trending. Regardless of what metric is used to determine the topics that are trending, the trending topic module 210 may be configured to ascertain whether a topic is trending in the content of a single online content source and whether a topic is trending in the content of multiple online content sources.

The functionality represented by the trending topic module 210 may be utilized together with the functionality represented by the demographic data prediction module 212 to implement techniques of trending data demographics. The demographic data prediction module 212 represents functionality to process demographic data in association with users that post content to one or more online sources, such as to service provider 110. The demographic data 208 may be used to segment users according to the demographic data. For example, the demographic data may be used to segment users into segments based on age, gender, and location, e.g., 30-34 year-old males in Washington, and 20-24 year-old females in California. The demographic data may also be used to segment users based on any one or more of age, gender, and location, e.g., all females, all males, or all females in California.

In one or more implementations, the demographic data prediction module 212 may be configured to collect demographic data 208 from user accounts 204 of users that post content on the online content sources. For example, the demographic data prediction module 212 may be configured to collect demographic data for a user from a single online content source, such as the online content source to which the user posted content. However, the demographic data prediction module 212 may also be configured to collect demographic data for a user from multiple online content sources. To do so, accounts held by the user at online content sources other than where the user posted the content may be ascertained and demographic data collected from those accounts.

The demographic data prediction module 212 may utilize this functionality to collect the demographic data 208 from the user accounts 204 of users that post content involving a topic that is trending. Furthermore, the demographic data prediction module 212 may be configured to selectively collect the demographic data 208 for users that post content involving trending topics, such that demographic data is not collected for users that did not post content involving trending topics. The collection of demographic data may also involve ascertaining at least some demographic data for a user relating to when the user posted about a trending topic. For example, demographic data indicating the user's location when it posted content involving the trending topic may be collected rather than demographic data indicating the user's hometown or birthplace.

Although demographic data may be collectible from the accounts of many users, oftentimes users may choose to make some or most personal information (including demographic data) associated with their user account private. Consequently, the demographic data prediction module 212 may not be able to collect the demographic data 208 from the user accounts 204 of some users. To address this, the demographic data prediction module 212 may be configured to assign demographic data to users that have chosen to keep their personal information from being collected. For example, the demographic data prediction module 212 may make use of characteristics exhibited in the content posted to the one or more online content sources. Naturally, the content posted to the one or more online content sources may exhibit certain characteristics, such as a use or absence of certain grammatical elements (e.g., punctuation), a use or absence of delimiters or features made available by a content source in conjunction with posts (e.g., hashtags, emojis, incorporation of digital pictures, and so on), a use or absence of certain phrases, and the like.

Before assigning demographic data to users, the demographic data prediction module 212 may attribute characteristics exhibited in content to corresponding demographic segments of users. In doing so, the demographic data prediction module 212 may process content that is posted to the online content sources by users having collectible demographic data. The content that is processed may be any content from which posting characteristics can be identified and that is posted by users having collectible demographic data. Accordingly, the content processed to attribute characteristics to the demographic segments may not be the same content from which trending topics are ascertained. In one or more implementations, the attributing of characteristics in posted content to corresponding demographic segments may involve training a classifier using the “bag-of-words” approach.

As an example, the demographic data prediction module 212 may process a variety of content to ascertain that content, including a single hashtag is generally posted by males and content including multiple hashtags is generally posted by females. Accordingly, the demographic data prediction module 212 may attribute single hastag use to males and multiple hashtag use to females. As another example, the demographic data prediction module 212 may determine that users older than 55 generally include a sign-off at the end of the content they post (e.g., “-Mark”), whereas users younger than 55 do not. Thus, the demographic data prediction module 212 may attribute the inclusion of a sign-off to users older than 55 and the exclusion of a sign-off to users younger than 55.

By attributing certain characteristics of posted content to corresponding demographic segments, the demographic data prediction module 212 may be configured to predict a user's demographic data based on characteristics identified in content posted by that user. To identify what characteristics are exhibited in content posted by a user, the demographic data prediction module 212 may process one or more pieces of content posted by the user to the one or more online content sources. The demographic data prediction module 212 may then compare the characteristics exhibited in those pieces of content to characteristics attributed to the one or more segments of users. The comparison may indicate that the characteristics identified in the content posted by the user correspond to those attributed to one or more of the segments. Accordingly, the demographic data prediction module 212 may assign the demographic data of those segments to the user for which the demographic data is being predicted.

As an example, content posted by a user may be processed to identify that the user frequently includes a single hashtag as part of posted content. If single hashtag use is attributed to males, as supposed above, then the demographic data prediction module 212 may assign demographic data to the user indicating that the user is a male. Based on the characteristics identified in the content posted by the user, the demographic data prediction module 212 may be configured to assign other demographic data to the user including, but not limited to, an age (or range of ages) and location (city, zip code, state, province, county, country, continent, and so on).

Using the mapping of characteristics exhibited in content to demographic segments of users, the demographic data prediction module 212 may assign demographic data to those users that post about a trending topic. By limiting the assigning to just the users that post about a trending topic, the demographic data prediction module 212 may conserve valuable time and resources that would result from additional processing. Further, the demographic data prediction module 212 may be configured to assign demographic data to a user that posts content involving a trending topic but for which demographic data cannot be collected. In one or more implementations, the demographic data prediction module 212 may be configured to assign demographic data to a user after unsuccessfully attempting to collect the demographic data from an account of the user.

Furthermore, the demographic data prediction module 212 may be configured to update the mapping of characteristics exhibited in content to corresponding demographic segments of users. For example, when demographic data is collectible for users that post about a trending topic, the demographic data prediction module 212 may process the content posted by those users to attribute characteristics exhibited in that content to the demographic segments to which the users correspond. However, the demographic data prediction module 212 may also be configured to use other data or content to update the mapping between characteristics exhibited in content and segments of users. For example, the demographic data prediction module 212 may be provided with additional data or content that is configured to update the mapping of characteristics exhibited in content to corresponding segments of users. As with the initial attributing, updating the mapping of characteristics to corresponding demographic segments may also involve training a classifier using the “bag-of-words” approach.

Along with representing functionality to collect and assign demographic data to users, the demographic data prediction module 212 also represents functionality to predict segments of users that are likely to find trending topics interesting. The demographic data prediction module 212 may be configured to do so based on the demographic data collected for and assigned to users who posted about the trending topic. For example, the demographic data collected and assigned in association with a particular trending topic may indicate that the users that posted about the trending topic are generally 20-24 year-old females in California. Accordingly, the demographic data prediction module 212 may predict that other 20-24 year-old females in California may be interested in the trending topic. The demographic data prediction module 212 may also predict, however, that 30-34 year-old males in Washington, people in California generally, and/or 20-24 year-old females generally, are likely to be interested in trending topics posted about by 20-24 year-old females in California. Thus, the segments of users that are likely to find the trending topics may include the segments of users that posted about the trending topic, but may also include different segments of users.

The segments of users that are likely to find a trending topic interesting may be information that is of value to several entities. Advertisers, for instance, may be interested in learning which users find a particular trending topic interesting. Given the segments of users that find a trending topic interesting, an advertiser may be able to provide targeted content (e.g., advertisements or suggestions) to those users. Accordingly, data indicating the segments of users that are likely to find a trending topic trending may be communicated to an advertiser. Although advertisers are specifically discussed, an indication of the segments of users that are interested in a trending topic may be of value to several other entities as well. For example, an online content source to which content involving trending topics is posted may be able to provide better content or functionality to its users given such data. Further, search engines may be able to provide users with more relevant search results given the segments of users that are likely to find a trending topic interesting. It follows then, that data indicative of the segments of users that are likely to find a trending topic interesting (or the demographic data thereof) may be provided to one or more entities (e.g., advertisers, search engines, the online content service providers themselves, and so on).

In some cases, data indicative of the segments of users likely to find a trending topic interesting may not be communicated to another entity. Trending data demographics may be implemented, for instance, by an advertiser, search engine, or online content provider where users can post content involving trending topics. Thus, the trending data demographics module 108 also represents functionality to provide targeted content to the segments of users that are likely to find the trending topics interesting, such as advertisements, suggestions for additional content, and so on.

Having discussed example details of the techniques for trending data demographics, consider now some example procedures to illustrate additional aspects of the techniques.

Example Procedures

This section describes example procedures for trending data demographics in one or more implementations. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks. In at least some implementations the procedures may be performed by a suitably configured device, such as the example computing device 102 of FIGS. 1 and 2 that makes use of a trending data demographics module 108.

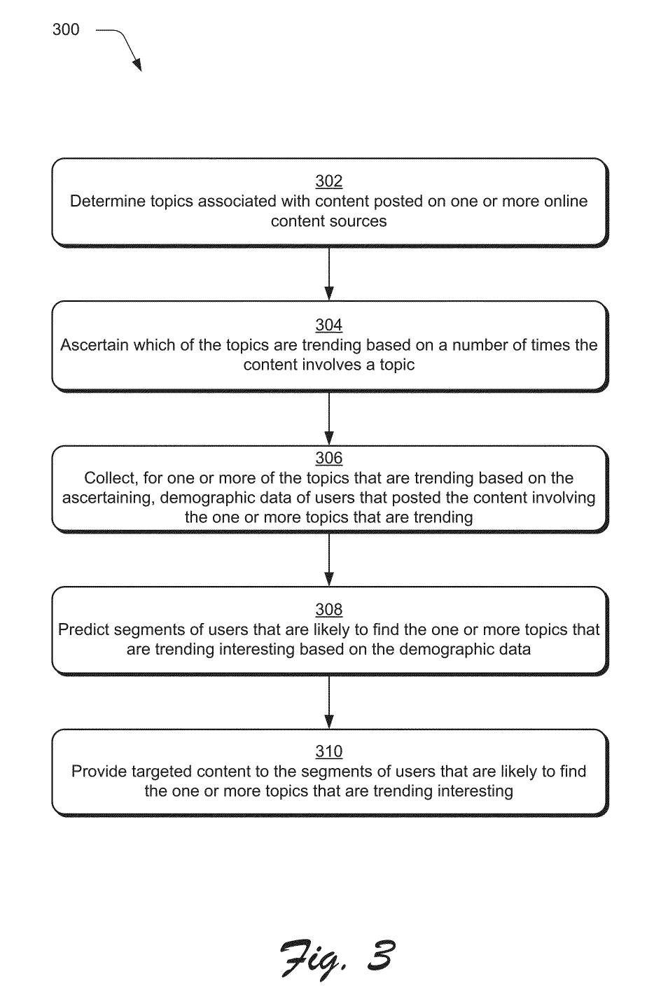

FIG. 3 depicts an example procedure 300 in which demographic data is collected for users that have posted about trending topics and is used to predict segments of users that are likely to find the trending topics interesting. Content posted on online content sources is analyzed to determine topics that are associated with the posted content (block 302). The trending topic module 210, for instance, may determine what topics (e.g., people, entities, and so on) are associated with the content 202.

Given the topics associated with the posted content, processing is performed to ascertain which of the topics in the posted content are trending (block 304). A determination as to which of the topics are trending may be based, in part, on a number of times the posted content involves a topic. For example, the trending topic module 210 may ascertain which of the topics associated with the content 202 (as determined at block 302) are trending, based on a number of times the content involves those topics.

For the topics that are trending, demographic data is collected for the users that posted about the trending topics (block 306). The demographic data prediction module 212, for instance, may collect the demographic data 208 from the user accounts 204 of the users that posted about the trending topics.

Based on the demographic data collected for the users that posted about the topics that are trending, a prediction is made to predict segments of users that are likely to find the trending topics interesting (block 308). For example, the demographic data prediction module 212 may predict segments of users that are likely to find the trending topics (as ascertained at block 304) interesting based on the demographic data 208 collected from the user accounts 204 of the users that posted about the trending topics.

Targeted content is provided to the segments of users that are likely to find the trending topics interesting (block 310). For example, the trending data demographics module 108 may cause targeted content to be provided to the segments of users that are likely to find the trending topics interesting (as predicted at block 308). To do so, the trending data demographics module 108 may communicate data indicative of those segments of users to one or more entities, such as advertisers, search engines, online service providers, other modules, and so on.

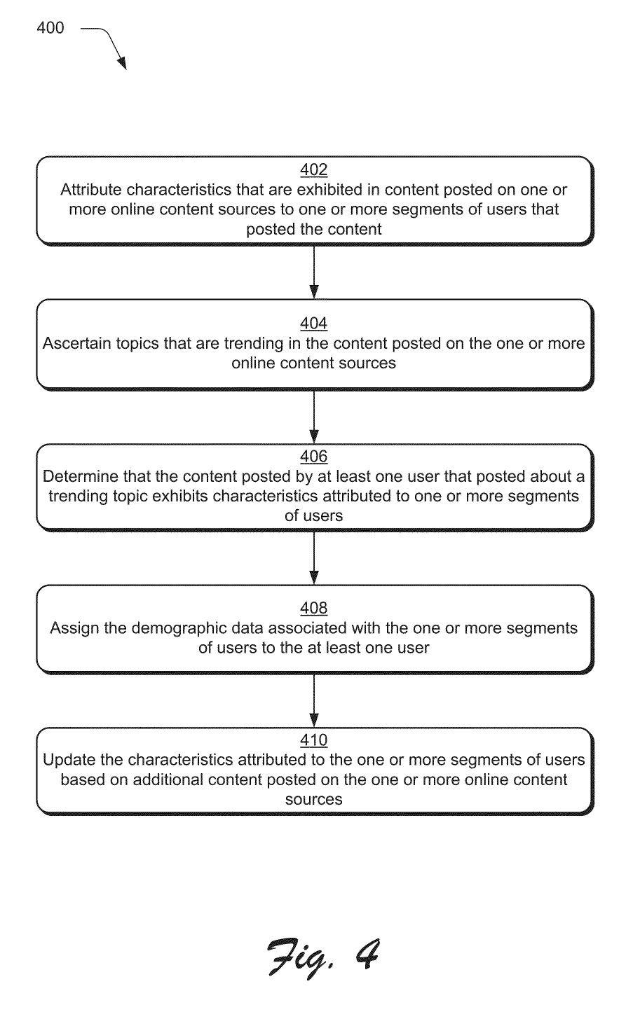

FIG. 4 depicts an example procedure 400 in which demographic data is assigned to users that have posted about trending topics to predict segments of users that are likely to find the trending topics interesting. As discussed in some detail above, content posted to online content sources may exhibit a variety of different characteristics, such as the use or absence of particular words or phrases, the use or absence of punctuation, and so on. Further, demographic data may be collected from online content sources for at least some of the users that post content therewith, e.g., those users for which the demographic data is publicly available. The demographic data that is available may be used to segment the users into groups according to the demographic data. Using this information, characteristics exhibited in content posted to online content source are attributed to segments of users that posted the content (block 402). For example, the demographic data prediction module 212 may attribute characteristics exhibited in the content 202 to corresponding demographic segments of users that posted the content.

The topics involved in content posted to the online content sources are analyzed to ascertain which topics are trending (block 404). For example, the trending topic module 210 may ascertain which of the topics associated with the content 202 are trending.

For at least one user that posted about a trending topic, content posted by that user is analyzed to determine what characteristics the user's content exhibits (block 406). In particular, the demographic data prediction module 212 may determine that content posted by a user about the trending topic exhibits characteristics attributed to one or more demographic segments of users. Based on characteristics exhibited in the posted content, demographic data associated with a segment of users is assigned to the user that posted about the trending topic (block 408). For example, the demographic data prediction module 212 may assign demographic data to the user that corresponds to the characteristics identified in content posted by the user.

The characteristics attributed to the segments of users are updated based on additional content posted on the online content sources (block 410). For example, the demographic data prediction module 212 may update a mapping of characteristics exhibited in content posted to the online content sources and the corresponding demographic segments the content exhibiting those characteristics.

Having described example procedures in accordance with one or more implementations, consider now an example system and device that can be utilized to implement the various techniques described herein.

Example System and Device

FIG. 5 illustrates an example system generally at 500 that includes an example computing device 502 that is representative of one or more computing systems and/or devices that may implement the various techniques described herein. This is illustrated through inclusion of the trending data demographics module 108, which operates as described above. The computing device 502 may be, for example, a server of a service provider, a device associated with a client (e.g., a client device), an on-chip system, and/or any other suitable computing device or computing system.

The example computing device 502 includes a processing system 504, one or more computer-readable media 506, and one or more I/O interfaces 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 506 is illustrated as including memory/storage 512. The memory/storage 512 represents memory/storage capacity associated with one or more computer-readable media. The memory/storage component 512 may include volatile media (such as random access memory (RAM)) and/or nonvolatile media (such as read only memory (ROM), Flash memory, optical disks, magnetic disks, and so forth). The memory/storage component 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

Input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 502 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media does not include signals per se or signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 510 and computer-readable media 506 are representative of modules, programmable device logic and/or fixed device logic implemented in a hardware form that may be employed in some implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of a module that is executable by the computing device 502 as software may be achieved at least partially in hardware, e.g., through use of computer-readable storage media and/or hardware elements 510 of the processing system 504. The instructions and/or functions may be executable/operable by one or more articles of manufacture (for example, one or more computing devices 502 and/or processing systems 504) to implement techniques, modules, and examples described herein.

The techniques described herein may be supported by various configurations of the computing device 502 and are not limited to the specific examples of the techniques described herein. This functionality may also be implemented all or in part through use of a distributed system, such as over a “cloud” 514 via a platform 516 as described below.

The cloud 514 includes and/or is representative of a platform 516 for resources 518. The platform 516 abstracts underlying functionality of hardware (e.g., servers) and software resources of the cloud 514. The resources 518 may include applications and/or data that can be utilized while computer processing is executed on servers that are remote from the computing device 502. Resources 518 can also include services provided over the Internet and/or through a subscriber network, such as a cellular or Wi-Fi network.

The platform 516 may abstract resources and functions to connect the computing device 502 with other computing devices. The platform 516 may also serve to abstract scaling of resources to provide a corresponding level of scale to encountered demand for the resources 518 that are implemented via the platform 516. Accordingly, in an interconnected device implementation, implementation of functionality described herein may be distributed throughout the system 500. For example, the functionality may be implemented in part on the computing device 502 as well as via the platform 516 that abstracts the functionality of the cloud 514.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1. A method comprising:
determining, by one or more computing devices, topics associated with content posted on one or more online content sources;
ascertaining, by the one or more computing devices, which of the topics are trending based on a number of times the content involves a topic; and
processing the content involving one or more of the topics that are trending to identify characteristics in the content, identification of the characteristics enabling the one or more computing devices to predict demographic data of users that posted the content involving the one or more topics that are trending, and the identification made by the one or more computing devices through a comparison of the characteristics in the content to posting characteristics attributed to one or more demographic segments of users.

2. A method as described in claim 1, further comprising:
predicting segments of users that are likely to find the one or more topics that are trending interesting based on the demographic data; and
providing targeted content to the segments of users that are likely to find the one or more topics that are trending interesting.

3. A method as described in claim 1, wherein the one or more online content sources include at least one of a social network, a blog, a news website, or a web service.

4. A method as described in claim 1, wherein:
the determining the topics associated with the content includes extracting keywords from the content; and
the ascertaining which of the topics are trending includes ascertaining which of the keywords extracted from the content are trending based on a number of times the content includes the keywords.

5. A method as described in claim 1, wherein the determining of the topics associated with the content is based, in part, on items in the content that are delimited by one or more delimiting characters.

6. A method as described in claim 1, wherein the determining of the topics associated with the content is based, in part, on resources specified by uniform resource locators (URLs) included in the content.

7. A method as described in claim 1, wherein the number of times the content involves the topic excludes reposts by users of content originally posted by another user.

8. A method as described in claim 1, wherein predicting the demographic data of the users is based on demographic data collected from user accounts with the one or more online content sources for at least one user that posted the content involving the topic that is trending.

9. A method as described in claim 1, wherein predicting the demographic data is based on determining that the content involving the one or more topics that are trending exhibits the posting characteristics attributed to the one or more demographic segments of users, and the one or more demographic segments are associated with the demographic data.

10. A method as described in claim 1, wherein the demographic data includes at least one of age, gender, and location of the users.

11. A method as described in claim 10, wherein the location of a user is based on time zone information for the content that is posted by the user involving the topic that is trending.

12. A method as described in claim 1, further comprising communicating the demographic data to an advertiser.

13. A method comprising:
attributing, by one or more computing devices, characteristics that are exhibited in content posted on one or more online content sources to one or more segments of users that posted the content, the users being segmented according to demographic data collected from the one or more online content sources;
ascertaining, by the one or more computing devices, topics that are trending in the content posted on the one or more online content sources; and
processing the content involving a trending topic to identify posting characteristics in the content, identification of the posting characteristics enabling the one or more computing devices to assign, to at least one of the users that posted about the trending topic, the demographic data associated with one or more of the segments of users based, in part, on a determination made by the one or more computing devices that the posting characteristics of the content posted by the at least one user map to the characteristics attributed to the one or more segments of users.

14. A method as described in claim 13, further comprising:
determining which of the segments of users are likely to find the trending topic interesting based on the demographic data assigned to the users that posted about trending topic; and
providing targeted content to the segments of users that are likely to find the trending topic interesting.

15. A method as described in claim 13, further comprising updating the characteristics attributed to the one or more segments of users based on additional content posted on the one or more online content sources.

16. A method as described in claim 13, wherein the demographic data is effective to segment the users by at least one of gender, age, or location.

17. A method as described in claim 13, wherein ascertaining the topics that are trending is based on a number of times the content involves the topics.

18. A system comprising:
at least one processor; and
a memory configured to store program instructions that are executable by the at least one processor to perform operations comprising:
predicting one or more segments of users that are likely to be interested in a topic that is trending in content posted to one or more online content sources, each of the segments representing users having respective demographic data, and the one or more segments that are likely to be interested in the topic that is trending being predicted based on the demographic data of users that posted about the topic that is trending, including:
collecting, for one or more of the users that posted about the topic that is trending, the demographic data from user accounts at the one or more online content sources corresponding to the one or more users; and
assigning, to one or more of the users that posted about the topic that is trending and for which the demographic data is not collected, the demographic data based on identifying that the content posted by those users exhibits characteristics attributed to the one or more segments in a mapping of posting characteristics to demographic segments.

19. A system as described in claim 18, wherein the operations further comprise attributing the characteristics that are exhibited in the content posted to the one or more online content sources to the respective segments of users that posted the content.

20. A system as described in claim 18, wherein at least one segment of users that is likely to be interested in the topic that is trending shares at least some demographic data with the users that posted about the topic that is trending.
